(19) United States
(12) Patent Application Publication
(10) Pub. No.: US 2010/0217716 A1
(43) Pub. Date: Aug. 26, 2010

(54) METHOD AND APPARATUS FOR RESTRICTING ACCESS TO AN ELECTRONIC PRODUCT RELEASE WITHIN AN ELECTRONIC SOFTWARE DELIVERY SYSTEM

(76) Inventors: Tobid PIEPER, Orinda, CA (US); Paul Martinelli, Berkeley, CA (US); Angela Chen, San Ramon, CA (US)

Correspondence Address: GLENN PATENT GROUP, 3475 EDISON WAY, SUITE L, MENLO PARK, CA, 94025, US

(21) Appl. No.: 12/713,958

(22) Filed: Feb. 26, 2010

Related U.S. Application Data
(63) Continuation of application No. 11/378,518, filed on Mar. 17, 2006, now abandoned.
Application No. 11/378,518 is a continuation-in-part of application No. 11/158,972, filed on Jun. 20, 2005.

(51) Int. Cl. G06Q 99/00; G06Q 50/00; G06F 21/22; G06F 17/30

(52) U.S. Cl. 705/310; 726/27; 717/172; 717/169

(57) ABSTRACT

The invention provides a method and apparatus for limiting access to a selected release of a software Product and/or associated License Keys to a subset of the manufacturer's customers who are entitled to receive the software Product or digital good, within an electronic software delivery and management system. A Product release is transmitted to the system for storage and limited distribution to a subset of entitled customers. A user interface enables the manufacturer, or partner such as a reseller, to specify distribution parameters that restrict distribution of the product version to specified customers. At least one customer is selected, such as, for example, one or more customers authorized to receive the product version. The product version is further designated as a restricted product version for the selected customers. Finally, the customer restriction information is stored in appropriate tables within a database.

### CROSS REFERENCE TO RELATED APPLICATION

This application is a continuation of co-pending U.S. patent application Ser. No. 11/378,518, filed on Mar. 17, 2006 and published on Dec. 21, 2006 as Pub. No. 2006/0288009 A1. The '518 application was a continuation-in-part of co-pending U.S. application Ser. No. 11/158,972, filed on Jun. 20, 2005 and published on Dec. 21, 2006 as Pub. No. 2006/0287957 A1. The entirety of the foregoing documents is incorporated herein by reference.

### TECHNICAL FIELD

The invention relates generally to the field of software management. More particularly, the invention relates to limiting access to selected electronic products and associated license keys to specific accounts.

### BACKGROUND OF THE INVENTION

Digital delivery has emerged as an efficient and profitable method of distributing digital goods such as, for example, software applications and/or data files. Often, a manufacturer may desire to limit or restrict delivery of a version or release of a software product or digital good and associated license keys.

Conventionally, software manufacturers have limited access to a software product by requiring provision of a key or password prior to accessing the software. Without the key, even if a non-entitled party had acquired a copy of a software product, the unauthorized copy was useless to the acquiring party. By selectively distributing the key, it was unnecessary for the manufacturer to control distribution of the software. However, distribution of licensing keys can be burdensome to the software manufacturer because the process is usually at least partly manual. Furthermore, keys and passwords can be readily passed from one user to another, easily thwarting the manufacturer's efforts. Additionally, keys and passwords are unsatisfactory in a scenario wherein the manufacturer wishes to limit distribution of a particular release of a software product to a subset of those entitled to the software. A manufacturer may wish to limit distribution of a release in such manner so that a product configuration can be verified prior to making it generally available. In this situation, it would be necessary to provide an additional key, or a special key, to the parties intended to receive the limited release. Additionally, the difficulty of controlling keys would make it difficult to restrict access to the limited release.

A manufacturer may also restrict distribution of a release by creating separate Entitlements or contracts for the restricted version. Such practice may be burdensome from an operational perspective, entailing creation of additional items in a product catalog and the processing of new orders for the product.

Commonly owned U.S. patent application Ser. No. 10/635,840 “Method and system for managing digital goods,” which is not admitted to be prior art to the present application by its mention in this “background section,” describes a platform for managing software Entitlements that provides an efficient method of distributing new software product releases to all consumers who have an appropriate Entitlement. In essence, the software publisher adds a new product release to a product definition. Doing so automatically makes the new product version and associated license keys available to all consumers who have current maintenance agreements; that is, those entitled to receive the new release. There are occasions when a software publisher might want to limit distribution of a new product release and its associated license keys only to a named subset of those entitled to receive the product, for example, to verify a product configuration before making it generally available. It would be desirable, therefore, to provide a way of selectively allowing access to a particular product release and/or its associated license keys only to a named subset of consumers. Thus, there exists a need in the art for an efficient method of providing access to a particular product release only to a subset of those entitled to the product until it is generally available.

### SUMMARY OF THE INVENTION

The invention provides a method and apparatus for limiting access to a selected version or release of a software product or digital good and/or its associated license keys to a subset of the manufacturer's customers who are entitled to receive the software product or digital good, within an electronic software delivery and management system. A product version or release and its associated license keys are transmitted to the system for storage and limited distribution to a subset of entitled customers. A user interface enables the manufacturer, or partner such as a reseller, to specify distribution parameters that restrict distribution of the product version to specified customers. At least one customer is selected, such as, for example, one or more customers authorized to receive the product version. The product version is further designated as a restricted product version for the selected customers. Finally, the customer restriction information is stored in appropriate tables within a database.

### BRIEF DESCRIPTION OF THE DRAWINGS

FIG. 1 is a block diagram illustrating an exemplary network environment including an apparatus for providing limited access to software products and associated keys within an electronic software delivery and management system according to one embodiment of the invention;

FIG. 2 is a block diagram illustrating a database, which at least partially implements and supports the apparatus for providing limited access to product releases according to one embodiment of the invention;

FIG. 3 is a flow diagram illustrating a method for facilitating input of customer restrictions associated with a product release and its associated keys, according to one embodiment of the invention;

FIG. 4 is a flow diagram illustrating a method for facilitating delivery of product releases and associated keys from software manufacturers and channel partners to restricted customers according to one embodiment of the invention;

FIG. 5 is diagram depicting an exemplary database schema for implementing customer restrictions associated with a product release according to one embodiment of the invention;

FIGS. 6-7 illustrate exemplary user interfaces for facilitating input of customer restrictions associated with a product release and associated license keys according to one embodiment of the invention; and

FIG. 8 is a diagrammatic representation of a machine in the exemplary form of a computer system within which a set of instructions may be executed.

### DETAILED DESCRIPTION

One aspect of the invention concerns an electronic software delivery and management (ESDM) system, more fully described in U.S. patent application Ser. No. 10/635,840, filed Aug. 5, 2003, the entirety of which is incorporated herein by this reference thereto. An embodiment of the ESDM system provides an Entitlement management platform that provides electronic software delivery (ESD) and electronic license delivery (ELD) for a range of digital goods. One or more of the following entities may be involved in the management of software Entitlements:
Catalog Item: an orderable item, also commonly referred to as a SKU (stock keeping unit). Within the context of the current invention, a catalog item constitutes a collection of one or more ‘Products.’
Product: a particular release or version of a software product or some digital good.
Account: the entity which defines the consumer.
Entitlement: an order. An Entitlement defines which Catalog Items are authorized to be accessed by the Account. An Entitlement may include one or more date ranges to define the period of a subscription or a maintenance contract; and
License keys.

As new Products are made available, they are associated to the appropriate catalog item. Each Account that has an effective Entitlement is automatically given access to the new Product by default. Additionally, one or more License Keys may be associated to the new Product.

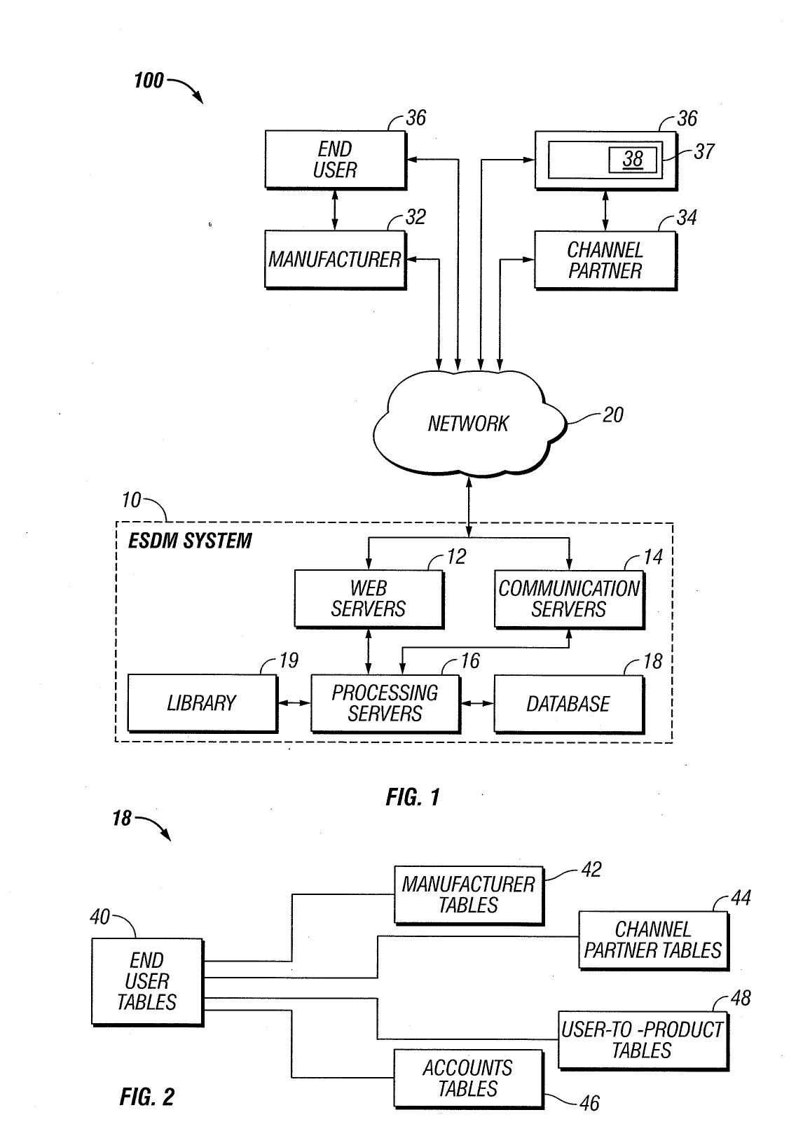

The invention may be embodied by various hardware components and interconnections, with one example being described by the exemplary network environment 100 of FIG. 1. The system 100 includes various subcomponents, each of which may be implemented by one or more hardware devices, software devices, a portion of one or more hardware or software devices, or a combination of the foregoing. The makeup of these subcomponents is described in greater detail below, with reference to an exemplary digital data processing apparatus, logic circuit, and signal bearing medium.

The environment 100, as illustrated in FIG. 1, includes multiple customers (exemplified by users 36) and an ESDM system 10. The customers 36 may also be referred to as a “client.” The ESDM system 10 may be accessed by a client program 38, such as a browser, for example, the Internet Explorer® browser distributed by Microsoft Corporation of Redmond WA, that executes on a client machine 37 residing at the customer's 36 site and accesses the system 10 via a network 20, such as, for example, the Internet. Other examples of networks that a client may use to access the system 10 includes a wide area network (WAN), a local area network (LAN), a wireless network, e.g. a cellular network, the Plain Old Telephone Service (POTS) network, or other known networks. The customer 36 seeks access to digital objects stored in a library 19, having earlier subscribed to (or been entitled by the owner or developer of the digital objects) to ESDM services offered by an ESDM entity that operates the ESDM system 10.

The environment 100 further includes multiple digital object manufacturers, such as, for example, software applications manufacturers (exemplified by manufacturer 32) and multiple channel partners (exemplified by channel partner 34), which also access the system 10 via the network 20. In one embodiment, the channel partner 34 may be a large entity in a predetermined business relationship with the manufacturer 32, such as, for example, a distributor of software applications or an original equipment manufacturer (OEM), which is enabled to access the system 10 and to place and process orders for the associated end users 36. Alternatively, the channel partner 34 may be a small entity in a predetermined business relationship with the manufacturer 32, such as, for example, an application partner of the manufacturer 32. The manufacturers 32 and channel partners 34 access the system 10 via corresponding client machines residing at their respective sites, each client machine having a corresponding browser.

The system 10 further includes one or more of a number of types of front-end web servers 12, such as, for example, web page servers, which deliver web pages to multiple users, picture servers, which deliver images to be displayed within the web pages, and content servers, which dynamically deliver content information to the customers 36, the manufacturers 32 and the channel partners 34. In addition, the system 10 may include communication servers 14 that provide, inter alia, automated electronic mail (email) communications to/from customers 36, manufacturers 32, and channel partners 34, and automated real-time communications, such as, for example, instant messaging (IM) functionality.

The system 10 further includes one or more back-end servers, such as, for example, processing servers 16 or FTP servers, for enabling functionality of the system 10, specifically for facilitating delivery of digital objects, such as, for example, software applications and/or associated License Keys, from software manufacturers 32 and channel partners 34 to their aggregated customer base (end users 36), as described in further detail below, and other known back-end servers configured to enable functionality of the system 10. The processing servers 16 are further coupled to a library 19, which stores the digital objects and associated License Keys, and a database 18, which may, in one embodiment, be implemented as a relational database, and which contains data related to the customers 36, the manufacturers 32, and the channel partners 34, as described in further detail below. In an alternative embodiment, the database 18 may be implemented as a collection of objects in an object-oriented database.

In one embodiment, the web servers 12 may be implemented by a variety of known machines, such as computer workstations, personal computers, etc. The web servers 12 also perform specific tasks such as presenting a web page providing instructions for customers seeking access to digital objects in the library, authenticating users according to the web server access codes, generating temporary FTP access codes for authenticated customers' use at the servers 16, and redirecting authenticated customers to the servers 16.

The servers 16 comprise some or all of one or more digital data storage machines, such as a UNIX, Linux, Microsoft NT, Microsoft Windows. The processing servers 16 perform specific tasks such as authenticating customers according to temporary access codes and, upon successful authentication, making digital objects from the library 19 available to the customers pursuant to a predetermined mapping.

In one embodiment, the ESDM system 10 serves to manage discovery and delivery of digital objects from the library 19 to customers 36 that are authorized to receive such objects by subscription, contract, payment, or other arrangement, such as, for example, customers 36 entitled to product documentation or applications comprised of several data objects. As a particular example, the ESDM system 10 may be implemented using the hardware structure (with various changes according to the present disclosure) used to implement the SubscribeNet® service of lntraware, Inc., of Orinda Calif., which has been in commercial use for some time.

The library 19 contains many different stored digital objects such as software, data constructs, data files, license keys or other machine readable digital objects. The library 19 comprises some or all of one or more data storage devices, machines, physical or logical storage constructs, etc, such as, for example, software programs, updates, revisions, and the like. For instance, a third party software producer may contract with the entity operating the ESDM system 10 to provide authorized customers with access to that third party's software applications and/or license keys.

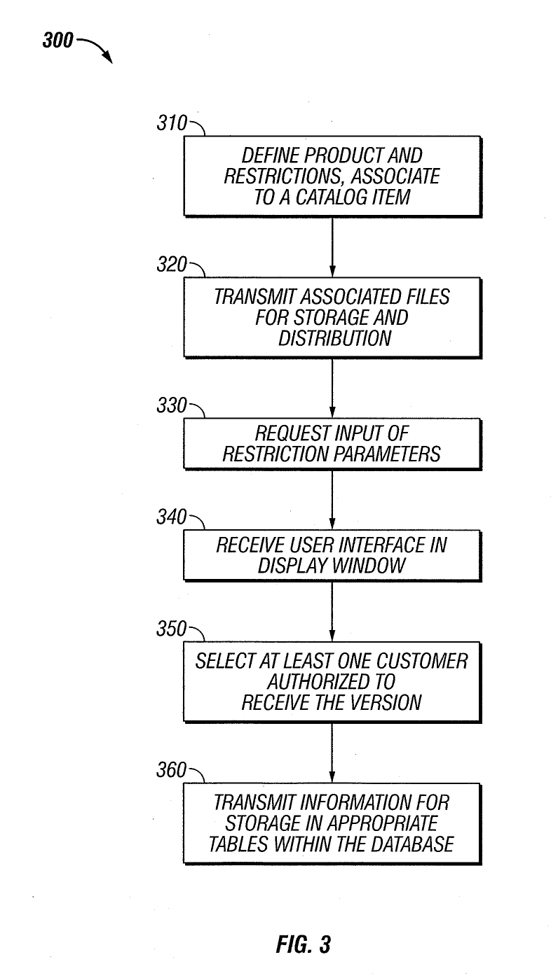

FIG. 2 is a block diagram illustrating a database 18, which at least partially implements and supports the ESDM system 10, according to one embodiment of the invention. The database 18 may, in one embodiment, be implemented as a relational database, and includes a number of tables having entries, or records, that are linked by indices and keys. In an alternative embodiment, the database 18 may be implemented as a collection of objects in an object-oriented database, or as a file system, linked list, directory server, e.g. LDAP (Lightweight Directory Access Protocol), Windows domain controller, or other suitable construct.

As illustrated in FIG. 2, in one embodiment, the database 18 contains various metadata relating to operation of the web servers 12 and processing servers 16. Central to the database 18 are one or more customer tables 40, which contain records for each entity or customer of the system 10. The database 18 also includes Accounts tables 46, which may be linked to the customer tables 40 and may be populated with Account, Product, and/or order information related to each user of the system 10, such as the manufacturers 32, the channel partners 34, and the customers 36.

In one embodiment, the customer tables 40 may include web server access codes, comprising a list of recognized customers (for example by user ID) and password or other login information required to use the web site supported by the web servers 12. The customer tables 40 may also contain a mapping of which customers are authorized to access which of the product releases associated with a catalog item to which they are entitled by subscription or purchase. Depending upon customer activity at any time, the database 18 may also contain various temporary FTP access codes, generated by the web servers 12 for customers to use in logging in to the system 10.

The database 18 may include a number of other tables, which may also be linked to the user table 40, for example, tables specifically provided to enable an exemplary embodiment of the invention. One or more manufacturer tables 42 are configured to store data related to the manufacturers 32 allowed to access the system 10 via the network 20, such as, for example, manufacturer codes, IDs, passwords, and other information. Furthermore, one or more channel partner tables 44 are configured to store data related to the channel partners 34 allowed to access the system 10 via the network 20, such as, for example, unique channel partner codes directly associated with one or more manufacturer codes representing specific manufacturers 32.

The database 18 further includes user-to-Product tables 48 configured to define which customers 36 can access specific Products. If a customer restriction is placed on a product release, such as for example, a beta version that has not been certified, then the product release and/or associated license keys are only exposed to the respective customer 36. Consequently, if no customer restrictions exist, then the product release and/or its key is available to any customer 36 entitled to receive the respective product release. In this way, the invention allows the manufacturer to hand-select customers to whom access to the restricted Product is granted. Thus, in the above example of a beta release, the manufacturer may, in a controlled way, make a beta release available only to a few internal users for testing. After the version is certified, the manufacturer can expand access, for example, to a larger subset of entitled users, or to the entire set of entitled users.

In one embodiment, each software manufacturer 32 controls the actions that an associated channel partner 34 may perform while accessing the system 10 by defining in the partner tables 44 which of the existing permissions apply to the respective channel partner 34. For example, the manufacturer 32 may define Accounts permissions, which enable the channel partner 34 to add and modify Accounts, order permissions, which enable the channel partner 34 to process and modify orders submitted by the end users 36 and/or by the channel partner 34, and Product management permissions, which enable the channel partner 34 to add and modify Product information stored in the library 19.

In one embodiment, each manufacturer 32 controls each channel partner's 34 access to Account, order, or product information that has originated from the respective manufacturer 32 by electing to share such information with specified channel partners 34. Thus, each Account, Product, or order in the Accounts tables 46 is configured to support multiple codes, manufacturer codes, channel partner codes, etc., with a specific manufacturer code assigned as the owner. In an alternate embodiment, each channel partner 34 controls each manufacturer's 32 access to Account, order, or Product information that has originated from the respective channel partner 34 by electing to share such information with specified manufacturers 32. Thus, each Account, Product, or order in the Accounts tables 46 is configured to support multiple codes, manufacturer codes, channel partner codes, etc., with a specific channel partner code assigned as the “owner.”

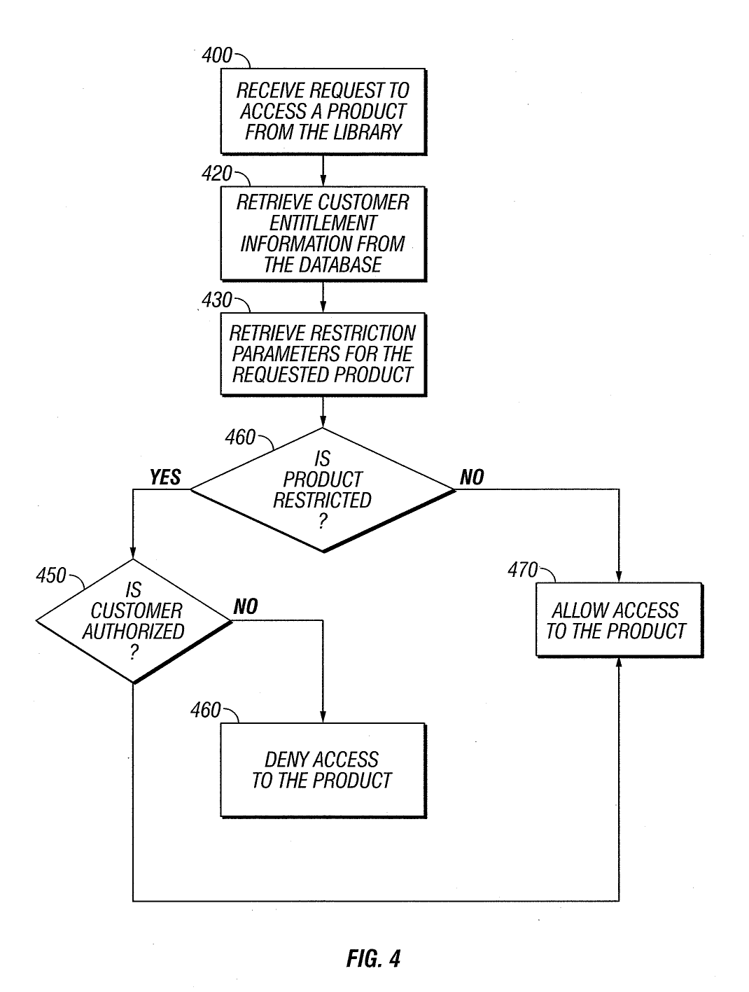

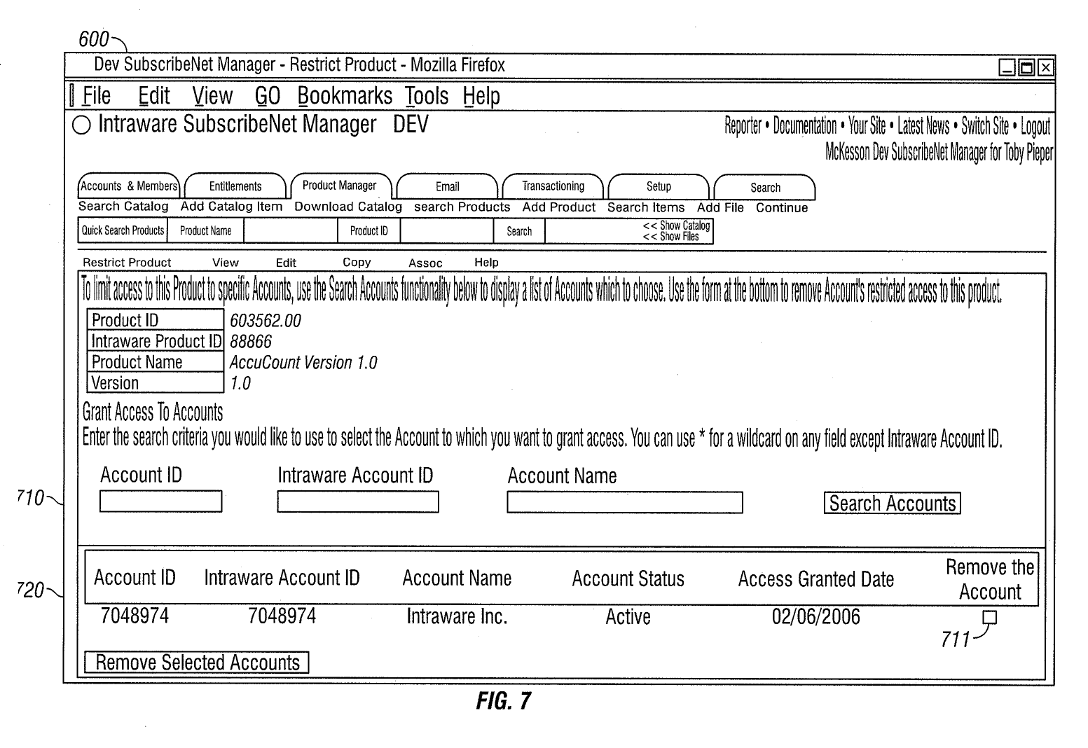

FIG. 3 is a flow diagram illustrating one embodiment for a method for facilitating input of customer restrictions associated with a selected product release or version. FIGS. 6 and 7 illustrate exemplary user interfaces for facilitating input of customer restrictions associated with respective Products or Files.

In an ESDM system, customers are authorized to access product releases or versions based on Entitlement data. An embodiment of the invention concerns:
How to limit access to a product release and/or associated keys to a named subset of those users entitled to the corresponding catalog item; and
How to make such a product release available without the need to create additional Entitlements.

Referring to FIG. 3, at processing block 310, a manufacturer defines and associates a new Product to a Catalog Item. As previously explained, a Catalog item is an orderable item of software. Generally, a Catalog item has at least one associated Product. A Product constitutes a product release, for example a new version of a particular computer program. The Product, in its turn, has associated to it at least one File. Files represent the actual software or data objects from which a Product is composed and which the customer downloads when the customer accesses a Product for download. A Product may also have associated to it one or more License Keys. A detailed description of Catalog Items, Products and Files and the means and methods by which they are defined and associated to each other is provided in U.S. Patent application Ser. No. 10/635,840.

At processing block 320, one or more data objects comprising the Product are transmitted to the system 10 for storage in the library 19. Additionally, any License Keys associated to the Product are also stored in the library 19. In one embodiment, a manufacturer 32 accesses the ESDM system 10 via the network 20, the web servers 12 and/or the communication servers 14 and stores a data object in the library 19. It is to be appreciated that the steps of defining the Product and storing the software objects comprising the File can be performed in any order, or they may be performed concurrently. In a case where the data objects are first stored in the library, when defining the resulting Product, it may be necessary to specify the path to the location in the library 19 where the data objects are to be found. In a case where the Product is first defined, it may be necessary to search for a record of the Product after the data objects have been transmitted and stored in order to associate the data objects to the Product.

At processing block 330, input of one or more restriction parameters is requested for the Product and/or one or more associated License Keys. In one embodiment, the manufacturer 32 accesses the EDSM system 10 via the network 20, the web servers 12 and/or the communication servers 14 and requests to input a restriction on the availability of the Product to certain customers 36 of the system 10.

At processing block 340, a user interface is received in a display window for facilitating input of the restriction parameters. In one embodiment, in response to the request, the processing servers 16 within the system 10 transmit an interactive user interface 600 to the manufacturer 32 via the front end servers 12, 14 and the network 20, the user interface 600 being illustrated and described in further detail in connection with FIGS. 6 and 7.

As illustrated in FIG. 6, the user interface 600 is displayed for the manufacturer 32 in a display window and further includes multiple tabs, links, data entry fields, interactive buttons, and/or icons which enable the manufacturer 32 to view Product information 660 stored in the database 18 and further facilitate input of customer restrictions. In one embodiment, the manufacturer 32 selects a Product tab 610 and selects a ‘restrict Product’ function 670 to request the display of Product information 660 from the system 10 via the network 20. The processing servers 16 within the system 10 receive the request, retrieve the data object information from the database 18 and display the information in the user interface 500 via the web servers 12 and the network 20. In one embodiment, the Product information may include, but is not limited to, Product identification information, a Product name, version number, status information, ownership information, any restriction information, associated License Keys and other specific technical information.

Next, at processing block 350, the manufacturer 32 selects at least one customer authorized to receive the Product by entering the desired search criteria to use to select an Account to which the manufacturer 32 wishes to grant access. In one embodiment of the invention, the search criteria may include such information as Account identification information, 620, 630, and Account name 640. In another embodiment of the invention, the manufacturer is able to enter search criteria that define groups and/or classes of customers to which the manufacturer may grant access to the Product. In either embodiment, with a conventional mouse click, the manufacturer activates a user interface element 650 that launches an Account search according to the specified parameters.

Having selected 350 at least one customer authorized to receive the Product, as the information is transmitted for storage in appropriate tables within the database 18, shown at processing block 360.

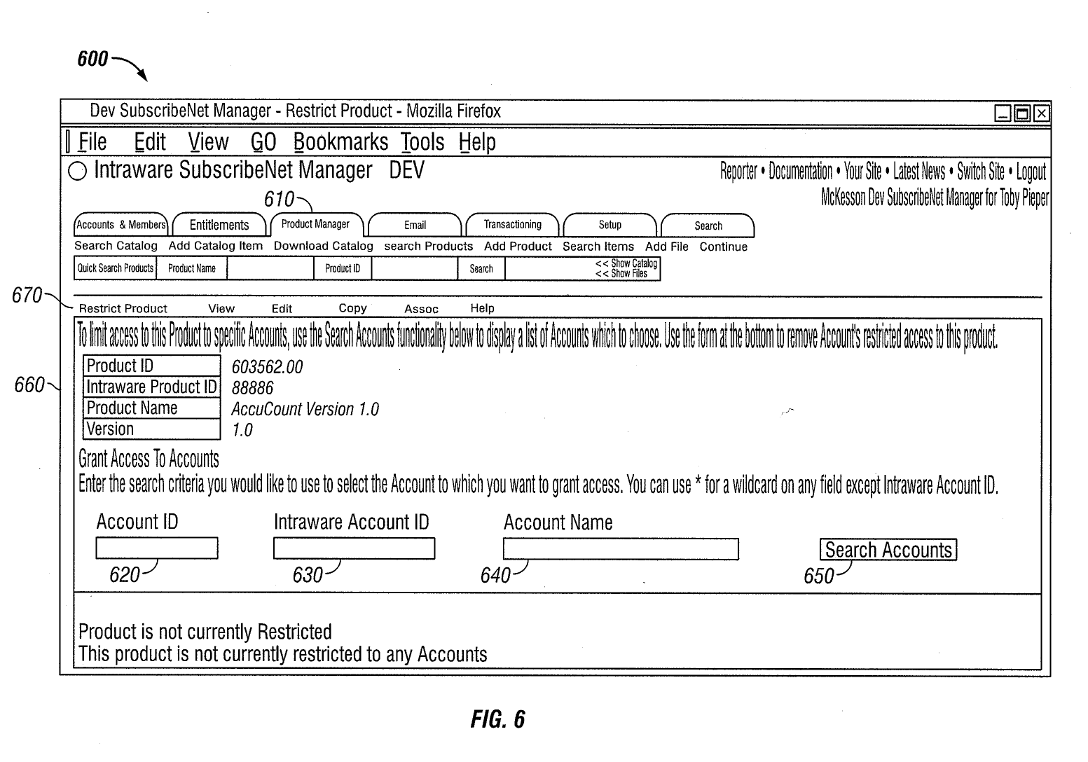

One embodiment of the invention employs a database schema 500 such as shown in FIG. 5 to store the Entitlement data to the restricted Product. To limit access to a Product to a subset of all entitled Accounts, the Product is restricted. A Product is restricted if there exist one or more restriction rows in a database table that define a restriction relationship between a Product and Accounts. If no restriction rows exist for a Product, the Product and/or its associated License Keys are not restricted and all Accounts with an appropriate Entitlement are granted access. If any restriction rows exist for a given Product, only Accounts which have both a valid Entitlement and at least one row in this table for that product are allowed access to the Product.

Table 1, below illustrates rights for various data sets. Table 1 assumes that all Accounts have full Entitlements.

TABLE 1

| Database | | Account A1 | Account A2 | Account A3 |
|---|---|---|---|---|
| Restriction | | has access | has access | has access |
| Product/Account | Product | to Product | to Product | to Product |
| P1/A1 | P1 | Yes | No | No |
| P2/A2 | P2 | No | Yes | No |
| P3/A1 | P3 | Yes | Yes | No |
| P3/A2 | | | | |
| (empty) | P4 | Yes | Yes | Yes |

The first row of Table 1 defines a Product restriction “P1/A1.” As above, the existence of a restriction row alerts the processing servers that the Product is restricted. Having restricted the software, the processing server evaluates the restriction row. Here, the restriction row positively defines an Account having access to the Product. Thus, Account A1 has access to Product P1. Because there exist no restriction rows for Accounts A2 and A3, they are excluded from access to Product P1. Looking now at row 2 of Table 1, the restriction row defines a relationship P2/A2. Thus, Account A2 is permitted access to Product P2, while Accounts A1 and A3 are excluded from access, there being no restriction rows for Accounts A1 and A3. Row 3 of Table 1 contains 2 restriction rows: P3/A1 and P3/A2. Thus, Accounts A1 and A2 have access to Product P3, while Account A3 is excluded. As shown in Row 4 of Table 1, there exist no entries for Product P4. The absence of restriction rows notifies the processing servers that P3 is not a restricted Product. Thus, Accounts A1, A2 and A3 are each granted access to Product P4 consistent with their each having a full Entitlement.

An Account definition table 510 stores information regarding customers. A Product definition table 530 stores Product definition information. Having selected one or more customers to whom access to a Product is granted, a restriction row for each Account/Product relationship is added to an Account/Product restriction table 520 in the manner described above. In one embodiment of the invention, restriction rows are defined using an Account identifier 521 and a Product identifier 522. One skilled in the art will appreciate that, in the presently described embodiment, the processing servers determine whether or not to restrict a Product by checking table 520 for the presence of restriction rows for the Product. If restriction rows are present, the software restricts the Product. After restricting the Product, the software associates Accounts to the Product according to the parameters defined by the restriction rows in table 520.

In one embodiment, the customers 36 may be subsequently removed from the Account area and the restriction status of the Product and/or its associated key may be changed, as illustrated and described in further detail in connection with FIG. 7.

As illustrated in FIG. 7, in one embodiment, the Account area of the user interface 600 further includes a Remove This Account box 711, associated with each displayed customer 36, and a Remove Selected Accounts button 720 for facilitating removal of the customer restrictions. The manufacturer 32 checks the box 711 pertaining to the customer 36 to be removed from the restriction list with a conventional mouse click command and activates the button 720 to request removal of the restricted access to the stored data object. The processing servers 16 receive the request via the network 20 and remove the customer restrictions from the tables 500 within the database 18.

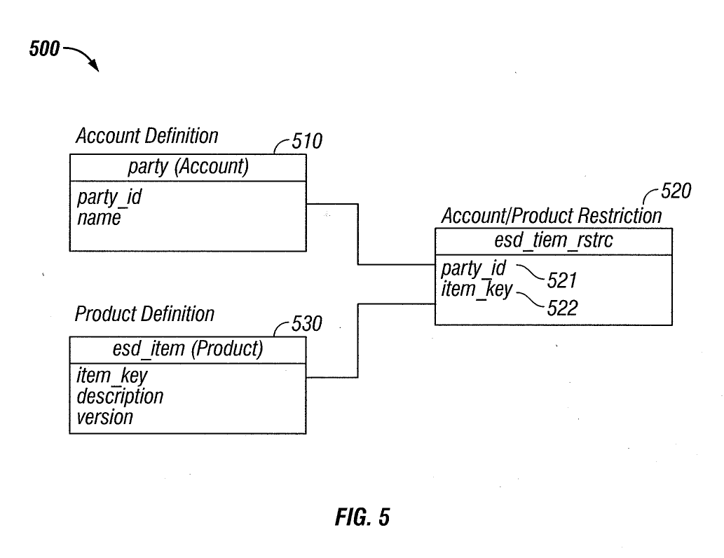

FIG. 4 is a flow diagram illustrating a method for facilitating delivery of Products from software manufacturers and channel partners to restricted customers. As illustrated in FIG. 4, in one embodiment, at processing block 400, a request to access a Product is received. In one embodiment, the processing servers 16 receive the request from a customer 36 via the network 20, the web servers 12, and/or the communication servers 14.

At processing block 420, customer Entitlement information is retrieved from the database 18. In one embodiment, responsive to the request, the processing servers 16 retrieve Entitlement information associated with the customer 36 from the tables 40 within the database 18. Referring now to the example provided in Table 1, the processing servers would find that each of Accounts A1, A2, and A3 had full Entitlements.

At processing block 430, restriction parameters for the Product are retrieved. Thus, as described above, it is determined whether there are exist any restriction rows for the Product for which access is requested. If there exist no rows in the database, the Product is not restricted. If there exist restriction rows, the Product is determined to be restricted.

At processing block 440, a decision is made whether the Product and or its associated keys is restricted to specific customers. In one embodiment, the processing servers 16 determine if the Product object has any associated customer restrictions.

If the Product is restricted to specific customers, then at processing block 450, a decision is made whether the customer 36 that requested the Product is authorized to access the data object. In one embodiment, the processing servers 16 determine if the customer 36 is authorized to access the Product. If the customer 36 is not authorized, then at processing block 460, access to the Product is denied. In one embodiment, the processing servers 16 transmit a denial of access to the customer 36 via the network 20, the web servers 12, and/or the communication servers 14.

Otherwise, if the stored Product has no associated user restrictions, or if the customer 36 is authorized to access the Product or the associated key, at processing block 470, access is allowed. In one embodiment, the processing servers 16 transmit an approval of access to the customer 36 via the network 20, the web servers 12, and/or the communication servers 14.

In one embodiment, when associating a new Product to a Catalog. Item, it is preferable to fully define Product restrictions before the Product is associated to the Catalog Item. Because, in the absence of any defined restrictions in the Product definition, processing servers distribute the Product to all entitled Accounts, there exists a risk that the Product may be distributed to one or more of the entitled Accounts before the manufacturer or channel partner has the opportunity to define the restrictions.

Another embodiment provides a ‘restricted’ flag in the Product record, wherein if the ‘restricted’ flag is set, the processing servers recognize that the Product is restricted, even in the absence of defined restrictions. Thus, because the risk of inadvertently distributing the software to Accounts not intended to receive it is greatly reduced, the software manufacturer or channel partner is granted greater freedom in defining the Product and its restrictions.

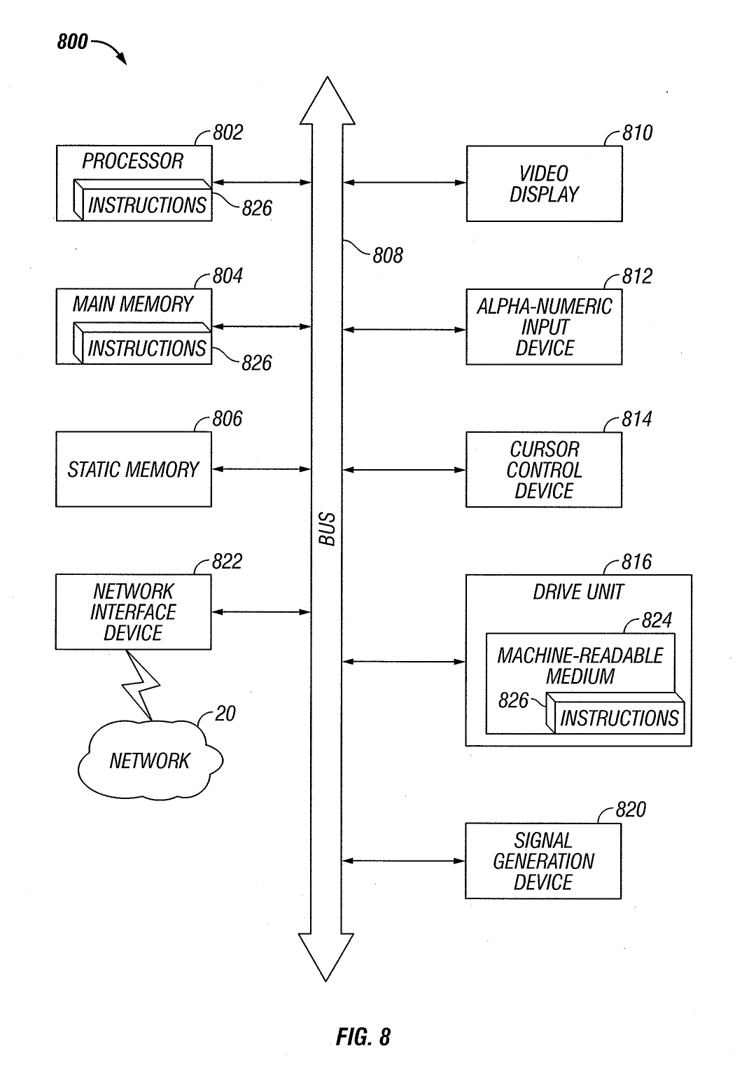

FIG. 8 shows a diagrammatic representation of a machine in the exemplary form of a computer system 800 within which a set of instructions, for causing the machine to perform any one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 800 includes a processor 802, a main memory 804 and a static memory 806, which communicate with each other via a bus 808. The computer system 800 may further include a video display unit 810, e.g. a liquid crystal display (LCD) or a cathode ray tube (CRT). The computer system 800 also includes an alphanumeric input device 812, e.g, a keyboard, a cursor control device 814, e.g. a mouse, a disk drive unit 816, a signal generation device 818, e.g. a speaker, and a network interface device 820.

The disk drive unit 816 includes a machine-readable medium 824 on which is stored a set of instructions, i.e. software, 826 embodying any one, or all, of the methodologies described above. The software 826 is also shown to reside, completely or at least partially, within the main memory 804 and/or within the processor 802. The software 826 may further be transmitted or received via the network interface device 820.

In contrast to the system 800 discussed above, a different embodiment of the invention uses logic circuitry instead of computer-executed instructions to implement processing entities such as the web servers 12, processing servers 16, etc. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS, TTL, VLSI, or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments of this invention may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, e.g. carrier waves, infrared signals, digital signals, etc.; or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. For example, the naming convention, which includes the terms Catalog Item, Account, Product, File and Entitlement is a matter of design choice and is not intended to be limiting. Entities substantially similar to those identified by the preceding descriptors, no matter the nomenclature, are within the scope of the invention. The specification and drawings are, accordingly, to be regarded in an illustrative sense rather than a restrictive sense.

1-24. (canceled)

25. A computer implemented network-connected electronic software delivery and management (ESDM) apparatus, operated by one party on behalf of multiple different third party entities for customers of the entities to retrieve files corresponding to the entities via the ESDM apparatus, the apparatus comprising:
a library programmed to receive and store multiple files comprising any one or more of software modules, updates, bug repairs, patches, and release notifications;
a database programmed to store information including information from the third party entities including: (1) product-file information establishing which of the files are associated with different digital products, (2) catalog information establishing which of the digital products are associated with different catalog items; (2) entitlement information specifying which customers are designated to have access to which of the catalog items;
a web server programmed to perform operations comprising:
responsive to receiving a request from one of the entities to input restriction parameters, the web server providing a web accessible interface structured to receive input of said restriction parameters by the requesting entity;
via the interface, the web server permitting the requesting entity to designate any one or more of digital products of the requesting entity as being restricted;
via the interface, for any digital products designated as restricted, the web server permitting the requesting entity to designate which customers shall have access to, or be restricted from access to, said restricted digital product; and
conducting authentication of customers requesting access to digital products in the library; and
a processing server coupled to the library, the database, and the web server, the processing server programmed to perform computer-implemented operations to manage customer access to digital products in the library, comprising:
receiving from the web server restriction information indicating which customers are restricted from accessing which digital products, and storing said received restriction information in the database;
responsive the web server receiving a request from an authenticated customer to access a digital product from the library, providing access only if the authenticated customer is designated for access to the requested digital product as indicated in the entitlement information as constrained by the restriction information for the digital product.

26. The apparatus of claim 25, where said operation of limiting access comprises:
responsive to a request from an authenticated customer to access a digital product from the library, limiting access to any of the requested digital product or a license key associated with the digital product to the customers designated to have access to the requested digital product as indicated in the entitlement information as constrained by the restriction information for the digital product.

27. The apparatus of claim 25, where the operation of the web server permitting the requesting entity to designate which customers shall have access to, or be restricted from access to, said restricted digital product comprises the requesting entity designating a named group or class or subset of customers.

28. The apparatus of claim 25, the operation of presenting metadata pertaining only to the digital products corresponding to the requesting entity, and permitting the requesting entity to designate digital products as being restricted comprises:
the web server presenting a searchable list of customers, and permitting the requesting entity to designate whether customers from the presented list shall have access to, or to be restricted from, said restricted digital product.

29. The apparatus of claim 25, the web server further programmed to perform operations comprising:
responsive to receiving a request from one of the entities, the web server providing a web accessible interface structured to receive changes to said restriction parameters by the requesting entity.
via the interface, for any products designated as being restricted, the web server permitting the requesting entity to amend which customers shall have access to, or be restricted from access to, said restricted digital product.

30. The apparatus of claim 25,
the processing server further programmed to perform operations comprising, responsive to the web server receiving designation of any one or more customers restricted from access to a digital product, making a representative entry in an account-product restriction table stored in the database;
where the operation of limiting access to each requested digital product comprises:
searching the account-product restriction table to determine whether there are one or more entries pertaining to the requested digital product;
responsive to the search failing to find any of such entries, permitting access to the requested digital product only if the authenticated customer is designated for access to the requested digital product as indicated in the entitlement information;
responsive to the search finding one or more of such entries, permitting access to the requested digital product only if (1) the authenticated customer is designated for access to the requested digital product as indicated in the entitlement information and (2) the entries do not restrict the authenticated customer from accessing the digital product.
